(19) United States
(12) Patent Application Publication
(10) Pub. No.: US 2009/0142150 A1
(43) Pub. Date: Jun. 4, 2009

(54) Tungsten steel cutter

(76) Inventor: Yang Tsuan Chu, Taichung (TW)

Correspondence Address: BRUCE H. TROXELL, SUITE 1404, 5205 LEESBURG PIKE, FALLS CHURCH, VA, 22041, US

(21) Appl. No.: 11/987,404

(22) Filed: Nov. 29, 2007

(51) Int. Cl. B23B 27/10; B23B 51/00

(52) U.S. Cl. 408/59; 408/226

(57) ABSTRACT

A tungsten steel cutter which is lower cost to use and can increase fabrication efficiency and improve quality mainly includes a shank and a bit screwing at a front end of the shank. Both are made of tungsten steel and formed in an integrated fashion. The shank has a screw hole at the front end and a coupling trough formed at the front end of the screw hole. The bit has a screw bar extended from the bottom end thereof and a coupling neck at the front section of the screw bar. The coupling trough is formed at a depth same as the height of the coupling neck and the coupling trough and the coupling neck are formed at the same size. The bit and the shank have respectively a water discharge passage and a water drawing passage, and a water intake passage that communicate with each other. The water intake passage is formed at a greater diameter than the water discharge passage and water drawing passage. Thus when the bit and the shank are screwed together, in addition to screw coupling of the screw hole and the screw bar, the coupling trough and the coupling neck also form a tight coupling to minimize gaps that might otherwise happen between them like the conventional ones do. The water discharge passage and water intake passage provide cooling effect for cutting fluid and prevent debris from accumulating on the bit and affecting cutting quality. The invention provides a two-section coupling that can save the cost and improve steadiness and fabrication efficiency of precision tools.

### BACKGROUND OF THE INVENTION

1. Field of the Invention

The present invention relates to a tungsten steel cutter and particularly to an improved tungsten steel cutter which is lower cost to use and can improve fabrication efficiency.

2. Description of the Prior Art

Precision and steadiness are important requiring features of cutters of precision tools. They usually are made of tungsten steel, high speed steel or ordinary steel. Nowadays the cutters are mostly made in an integrated fashion. For instance, the cutter made of tungsten steel in an integrated fashion is steadier and can provide a better cutting quality. The cutter generally wears out most seriously at the bit portion. Once the bit is damaged, the entire cutter has to be replaced. Hence the cost is high. To remedy this problem, sectional cutters have been developed that have a shank and a bit soldered together. In the event that the bit is worn out, it can be replaced to save cost. The shank usually is made of ordinary steel. Thus the bit and the shank have different hardness. While such a structure has a lower cost than the conventional integrated cutter, its bounding intensity is poorer. And the different hardness makes fabrication less steady and precision less desirable.

Moreover, during cutting operation high speed friction between the cutter and the working piece generates heat. Hence cutting fluid is needed to prevent the cutter and the working piece from overheated and deformation. The cutting fluid also carries away debris occurred during the cutting operation. However, because of design problem of the cutter the cutting fluid does not stay on the cutter for long. Hence usage of the cutter fluid is huge, and debris discharge effect also in not desirable. Moreover, the debris even tends to accumulate on the flutes formed between the cutting edges. This affects cutting smoothness and quality.

### SUMMARY OF THE INVENTION

In view of the aforesaid problems, the present invention aims to provide an improved cutter that has a shank and a bit that are made of tungsten steel and formed respectively in an integrated fashion. They can be bonded tightly together by screwing. The bit and shank have respectively a water discharge passage and a water intake passage to allow cutting fluid to provide cooling and prevent accumulation of debris on the bit to affect cutting quality. Such a structure overcomes the shortcomings of the conventional cutters.

Thus the primary object of the invention is to provide an improved tungsten steel cutter that is lower cost to use and can improve fabrication efficiency.

Another object of the invention is to provide a structure to allow cutting fluid to flow through inside of the bit to prevent debris accumulation and impact of cutting quality and also lower the temperature during cutting operation.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a perspective view of the invention in an assembled condition.

FIG. 3 is a sectional view of the invention in an assembled condition.

FIG. 4 is a schematic view of another embodiment of the invention.

FIG. 5 is a schematic view of yet another embodiment of the invention.

### DESCRIPTION OF THE PREFERRED EMBODIMENTS

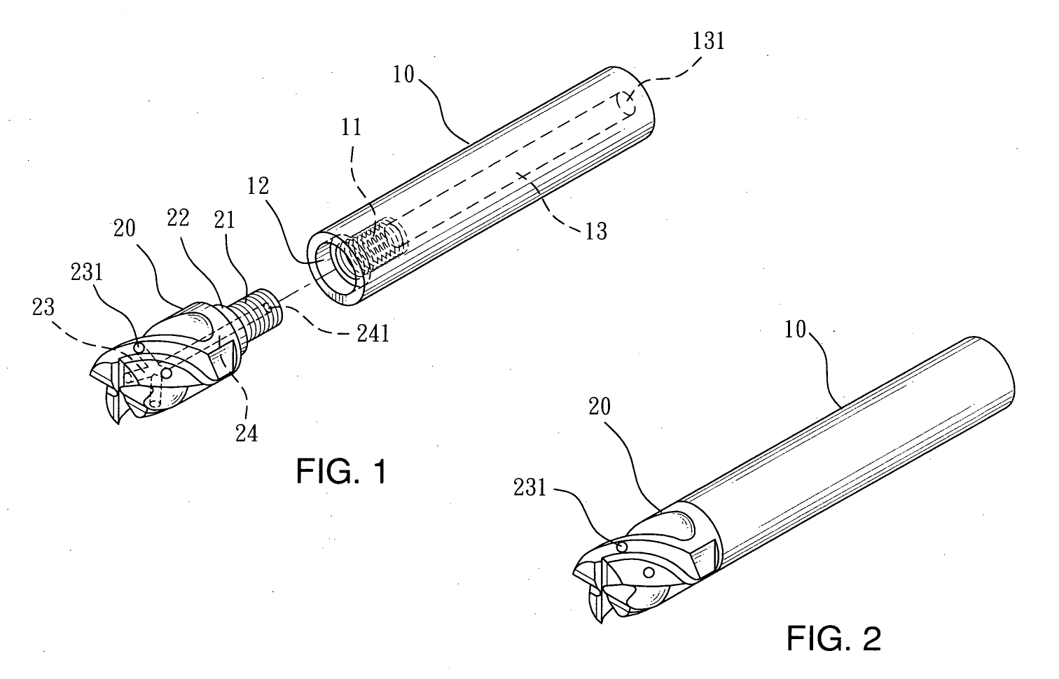

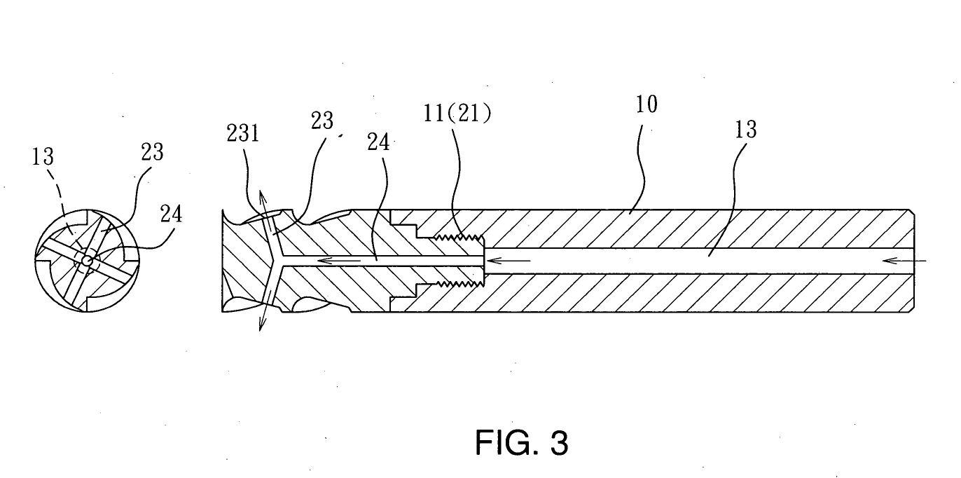

Referring to FIGS. 1, 2 and 3, the invention mainly includes a shank 10 and a bit 20.

The shank 10 is made of tungsten steel and formed in an integrated fashion. It has an indented screw hole 11 at a front end and a coupling trough 12 formed at the front end of the screw hole 11. There is a water intake passage 13 under the coupling trough 12 and a water inlet 131 at a distal end of the water intake passage.

The bit 20 is made of tungsten steel and formed in an integrated fashion. It has a screw bar 21 extended from the bottom end and a coupling neck 22 at a front section of the screw bar 21. The coupling neck 22 is formed at a height same as the depth of the coupling trough 12 and at a size mating the coupling trough 12. The bit 20 has cutting edges each has a water outlet 231 on an inner wall thereof. The water outlet 231 inclines towards the center to form a water discharge passage 23 which leads to a water drawing passage 24 in the center. The water drawing passage 24 runs through the screw bar 21 and forms a water drawing port 241 at the bottom of the screw bar 21 to be connected to the water intake passage 13. Seeing from a side sectional view, the water discharge passage 23 and the water drawing passage 24 form a Y-shape duct, and also have substantially a same diameter, but is smaller than the water intake passage 13.

By means of the construction set forth above, when the bit 20 is screwed with the shank 10, the screw hole 11 is engaged with the screw bar 21 by screwing, and the coupling trough 12 and the coupling neck 22 form a tight coupling. The gap between them can be minimized, thus steadiness and fabrication efficiency of precision tools improve.

During cutting operation cutting fluid enters through the water inlet 131 into the water intake passage 13, then through the water drawing port 241 into the water drawing passage 24 and flows into the water discharge passage 23 and is discharged through the water outlet 231. As the diameter of the water intake passage 13 is greater than the water drawing passage 24, the cutting fluid is gathered in the water drawing passage 24 to be fully distributed and flow to the water discharge passage 23, and discharged through the bit 20. A pressure difference is formed to provide directing flushing effect to prevent the bit 20 from overheating. Thus an effective cooling effect can be achieved. And debris also can be carried away smoothly to avoid accumulating on the bit 20.

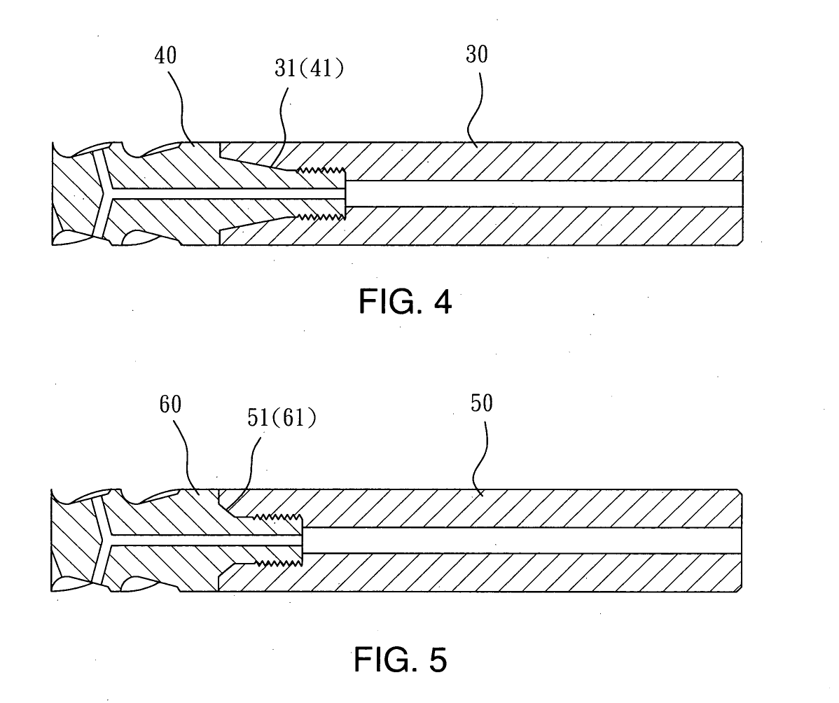

Referring to FIG. 4 for another embodiment of the invention. It has a coupling trough 31 formed in a shank 30 in a conical shape expanded from the center towards the outer side. A bit 40 has a coupling neck 41 formed in a conical shape but is tapered towards the center. By means of the conical design the bit 40 and the shank 30 have a larger contact area. Hence coupling of the shank 30 and the bit 40 is positioned more precisely. Because of the larger contact area of the two, coupling steadiness also is enhanced. Refer to FIG. 5 for yet another embodiment of the invention. It has a coupling trough 51 in a shank 50 formed with an inclined surface. And a bit 60 is provided with a coupling neck 61 also formed with an inclined surface. Such a structure also can accomplish the result previously discussed.

As a conclusion, the tungsten steel cutter of the invention provides an improved structure and can provide steadier and more precise coupling, and achieve the objects set forth above. It offers a significant improvement over the conventional cutters.

I claim:

1. A tungsten steel cutter comprising a shank and a bit at a front end of the shank that are screwed together, wherein:
the shank and the bit are made of tungsten steel and formed in an integrated fashion, the shank having a screw hole at the front end, a coupling trough formed at a front end of the screw hole, a water intake passage located under the coupling trough and a water inlet at a distal end of the water intake passage; and
the bit has a screw bar extended from a bottom end thereof and a coupling neck formed at a front section of the screw bar;
wherein the coupling trough is formed at a depth same as the height of the coupling neck and the coupling trough and the coupling neck are formed at a same size, the bit having cutting blades each having a water outlet on an inner wall thereof, the water outlet inclining towards the center to form a water discharge passage which leads to a water drawing passage in the center, the water drawing passage running through the screw bar and forming a water drawing port at the bottom of the screw bar to be connected to the water intake passage.

2. The tungsten steel cutter of claim 1, wherein the coupling trough is formed in a conical shape expanded from the center towards an outer side, the coupling neck being formed in a conical shape tapered towards the center.

3. The tungsten steel cutter of claim 1, wherein the water drawing passage and the water discharge passage have a smaller diameter than the water intake passage.
